(19) United States
(12) Patent Application Publication
(10) Pub. No.: US 2012/0190777 A1
(43) Pub. Date: Jul. 26, 2012

(54) COATING COMPOSITION CONTAINING BIOBASED MATERIALS

(75) Inventors: P. James HOUSTON, Richfield, OH (US); Donald C. LINEBERRY, Cambridge Springs, PA (US); Paul E. MARSHALL, JR., Wooster, OH (US)

(73) Assignee: ELASTIKOTE, LLC, Akron, OH (US)

(21) Appl. No.: 13/014,192

(22) Filed: Jan. 26, 2011

(51) Int. Cl. C09D 153/00; C08K 5/1515

(52) U.S. Cl. 524/27; 524/505; 524/114

(57) ABSTRACT

An elastomeric coating composition that includes biobased materials in a solvent system for application to the exterior surface of a structure. The coating composition includes at least one tackifier, a block copolymer, an acrylic resin, at least two biobased materials, and an organic solvent system.

### TECHNICAL FIELD

The invention relates to protective coatings for a surface of a structure. More particularly, the invention relates to an elastomeric coating composition that includes biobased materials in a solvent system for application to the exterior surface of a roof. Even more particularly, the invention relates to an elastomeric coating composition containing biobased materials in a solvent system having a calculated volatile organic content (VOC) of less than 250 g/L.

### BACKGROUND OF THE INVENTION

Structures used in construction, such as foundations, walls, and roof structures, include materials, such as masonry, cement, wood, plaster, stone, clay or brick that may be porous. Such porous materials can be degraded by water and/or loss of water from the porous materials. Below grade structures are often subjected to hydrostatic pressure from ground water. Above grade structures are subject to precipitation and water from other sources. A variety of methods and products for waterproofing and/or sealing these structures against outside water have been developed.

One type of waterproofing and/or sealing system includes polyvinyl or polyethylene sheeting adhered or fastened to the surface of the structure. If an adhesive is used to adhere the sheeting to the structure, the adhesive may not stick well due to dust (e.g., cement or stone dust) produced during construction and other activities and lose its adhesion over time. Additionally, if fasteners, such as nails or staples, are used to attach the sheeting to the structure, the fasteners typically puncture the sheeting and the structure beneath, providing a channel through which water can flow. Moreover, there are seams between the sheets that require the use of a fastener or adhesive to close. The adhesive may be attacked by microorganisms and/or oxidation and degraded or may dissolve in water over time, allowing water to flow through the seam. Fasteners puncture the sheeting and allow water through the resulting holes. In addition, the waterproofing sheets are often difficult to form around non-uniform structures and adverse weather conditions may hinder the placement of the sheets on the structure. For example, wind may cause wrinkles in the sheet as it is positioned on the structure and, on very cold days, the sheets may tear or even shatter during installation.

Another type of waterproofing and/or sealing system includes the application of a coating composition on the structure. One common type of coating composition for waterproofing and sealing is a tar/asphalt-based coating. Although this type of composition is relatively inexpensive and can be applied year-round, the materials in the composition often leach away from the wall. This often contaminates the soil and reduces the amount of protection afforded by the coating. Furthermore, these compositions typically contain a large amount of organic material which may be attacked by microorganisms, thereby reducing the effectiveness of the coating.

Other types of coating compositions have been developed. Many of these coating compositions, however, do not produce a durable film over porous substrates (e.g., cement, masonry blocks, wood, etc.). Often, the film that is formed using these coating compositions is easily punctured and/or includes components that are degradable or leach away from the film thus losing its adhesion to substrates. These coating compositions need to be applied with a significant amount of volatile organic compounds as solvents. These emitted volatile organic compounds (VOCs) are limited by current environmental regulations. Moreover, a number of the coating compositions are difficult to apply to the various substrates.

The United States Department of Agriculture (USDA) has developed the BioPreferred^{SM} program, which aims to increase the purchase and use of renewable, environmentally friendly biobased products while providing “green” jobs and new markets for farmers, manufacturers, and vendors. The goal of the BioPreferred program is to offers benefits including climate change impact reduction, energy/environmental security, and economic development.

The BioPreferred program was created by the Farm Security and Rural Investment Act of 2002 (2002 Farm Bill), and expanded by the Food, Conservation, and Energy Act of 2008 (2008 Farm Bill) to increase the purchase and use of biobased products. The BioPreferred program includes a preferred procurement program for Federal agencies and their contractors, and a voluntary labeling program for the broad scale consumer marketing of biobased products.

Under the procurement program, the BioPreferred program designates items, or generic groupings of biobased products, that are required for purchase by Federal agencies and their contractors. As a part of this process, the minimum biobased content is specified and information on the technical, health, and environmental characteristics of these products are made available on the BioPreferred Web site. Under the voluntary labeling program, biobased products that meet the BioPreferred program requirements will soon carry a distinctive label for easier identification by government, businesses and consumers.

Within the BioPreferred program is a BioPreferred Catalog which provides Federal and contractor personnel with a searchable database of biobased products. One of the categories within the BioPreferred Catalog is roof coatings which falls under Construction and Road Maintenance—Sealants and Coatings.

Notwithstanding the state of the art as detailed herein, there is a need for an improved roof coating composition containing biobased materials in a solvent system for use in waterproofing applications that meets the criteria established by the USDA for the BioPreferred program.

### SUMMARY OF THE INVENTION

In general, one aspect of the invention is to provide an elastomeric waterproofing coating composition that is compliant with the USDA BioPreferred program and contains a minimum of 20 percent biobased materials based upon total solids in the composition. The coating composition, when applied to an exterior surface of a structure, such as a roof, will result in a uniform and consistent coating on the exterior surface of the structure that is impermeable to water upon curing.

In general, the invention provides a non-aqueous coating composition for waterproofing a surface of a roof. The composition includes at least one tackifier, a block copolymer selected from the group consisting of styrene-isoprene-styrene block copolymers, styrene-butadiene-styrene block copolymers, and styrene-ethylene/butylene-styrene block copolymers and mixtures thereof, an acrylic resin, at least two biobased materials, and an organic solvent system.

In yet another aspect of the invention, a roofing primer composition is provided. The roofing primer composition includes at least one tackifier, a block copolymer selected from the group consisting of styrene-isoprene-styrene block copolymers, styrene-butadiene-styrene block copolymers, and styrene-ethylene/butylene-styrene block copolymers and mixtures thereof, an acrylic resin, at least one flour material selected from the group consisting of ground cereal grains, ground seeds, and ground roots, and an organic solvent system.

At least one or more of the foregoing objects of the present invention together with the advantages thereof over the prior art will become apparent from the description of the invention that follows. Exemplary compositions of the coating and methods of applying such coating are described herein by way of example. The specification does not attempt to show all the various forms and modifications in which the present invention might be embodied, rather the invention should be measured by the claims presented herein.

### DETAILED DESCRIPTION OF THE INVENTION

The present invention is generally directed to a protective coating for a surface of a structure. More particularly, the invention is directed to a waterproofing composition containing biobased materials in a solvent system for application to the exterior surface of a structure. The structure includes, by way of example, foundations, basement walls, retaining walls, cement posts, other building walls, dry wall, pool enclosures, tub and shower enclosures, highway structures (e.g., posts and walls), wooden or metal fence posts, sheet rock, plywood, wafer board, wall sheeting, pressed board, containment basins and walls, fabricated walls, floor panels, roofs, plaza decks, decks, floors, concrete, pre-stressed concrete other substrates that are buried or are exposed to water or weathering conditions, and the like. These structural units are typically made from masonry, cement, wood, plaster, stone, gypsum, clay, brick, tile, terra cotta, cardboard, paper, and the like.

In one embodiment of the invention, a non-aqueous coating composition for waterproofing a surface of a roof includes at least one tackifier, a block copolymer, an acrylic resin, at least two biobased materials, and an organic solvent system.

The tackifier is selected from the group consisting of an aliphatic hydrocarbon resin, a polybutene hydrocarbon resin, a polyterpene hydrocarbon resin, and mixtures thereof. In one embodiment, the tackifier of the coating composition is a hydrocarbon resin. The hydrocarbon resin used in accordance with the invention are typically low molecular weight polymers (oligomers) produced from by-product hydrocarbon, petroleum or coal tar streams. Polymerization is carried out using any one of a number of acid catalysts or as a free radical reaction using heat and pressure. The hydrocarbon resin includes both natural and synthetic types including aliphatic and aromatic resins.

For example, the hydrocarbon resin may be a hydrogenated polyalicyclic resin such as P-95, P-115, P-125 or P-140, commercial products available from Arakawa Chemical; or Escorez 5380, 5300, 5320 or 5340, commercial products available from ExxonMobil Chemical; or Regalite R91, R101, R125 or S260 or Regalrez 1018, 1085, 1094, 1126, 1128, 1139, 3102, 5095 or 6108, products available from Hercules; or Eastotac H-100W, H-115W or H-130W, all available from Eastman Chemical. The resin may also be an aliphatic hydrocarbon resin such as Escorez 1102, 1304, 1310LC, 1315 or 1504, commercial products available from ExxonMobil Chemical; or Nevtac 10, 80, 100 or 115, products available from Neville Chemical; or Wingtack 10, 95 or Plus, all available from Goodyear Tire & Rubber; or Eastotac H-100E, H-100R, H-100L, H-115E, H-115L, H-130E, H-130R or H-130L, commercial products available from Eastman Chemical; or Piccotac B, Piccotac 95 or Piccotac 115, products available from Hercules. The resin may be an aromatic hydrocarbon resin such as Nevchem 70, 100, 110, 120, 130, 140 or 150, products available from Neville Chemical; or Escorez 7105 or 7312, commercial products available from ExxonMobil Chemical; or Picco 1104, 2100, 5120, 5130, 5140, 6085, 6100, 6115 or 9140, or Piccodiene 2215 or Piccovar AP10, AP25 or L60, products available from Hercules. Additionally, the tackifier of the present invention may be mixtures of these or other suitable resins. In one embodiment of the invention, the tackifier is Eastotac™ H-130 and generally comprises about 5.0-22.0% by weight of the coating composition. In a preferred embodiment, the tackifier comprises about 5.0-10.0% by weight of the coating composition.

Useful block copolymers of the coating composition are well-known in the art and are commercially available. In one embodiment of the invention, the block copolymer is selected from the group consisting of styrene-isoprene-styrene block copolymers, styrene-butadiene-styrene block copolymers, and styrene-ethylene/butylene-styrene block copolymers and mixtures thereof. Typically the molecular weight of suitable polymers will be in the range of about 60,000 to about 180,000. In addition, the styrene content, the isoprene content, the butadiene content, the ethylene content, and/or the butylene content may be adjusted in order to adjust the final physical properties of the coating composition accordingly.

For example, the block copolymer may be a polymer of styrene-butadiene-styrene type such as Kraton D1101, D1102, D1116, D1118, D1122, D1184 or D1300, all available from Kraton polymers; or Calprene C-401, C-411, C-411X, C-412, C-416, 419, 484, 485, 487, 500 or 501, commercial products available from Dynasol Elastomeros. The block copolymer may be a polymer of a styrene-isoprene-styrene type such as Kraton D 1107, D1111, D1112, D1113, D1117, D1119, D1124, D1125, D1193 or D1320, commercial products available from Kraton Polymers; or KTR-801 or KTR-802, available from Momentum Technologies. The block copolymer may be polymer of a styrene-ethylene-butadiene-styrene type such as Kraton G1650, G1651, G1652, G1654, G1657, G1726, G7723 or GRP6919, commercial products available from Kraton Polymers; or Calprene H-6110, 6120, 6140 or 6170, all available from Dynasol Elastomeros. The block copolymer may be a polymer of a styrene-ethylene-propylene type such as Kraton G1701 or G1702, commercial products available from Kraton Polymers. The block copolymer may be a polymer of an ethylene-propylene type such as Kraton G1750 or G1765, commercial products available from Kraton Polymers. Additionally, the block copolymer component may be a combination of such copolymers. Generally, the coating composition will include less than about 25% by weight of the block copolymer. In one embodiment of the invention, the block copolymer is Calprene H-6110 and/or Kraton G1652 and generally comprises about 8.0-28.0% by weight of the coating composition. In a preferred embodiment, the block copolymer comprises about 10.0-15.0% by weight of the coating composition.

The acrylic resin of the coating composition is an acrylic polymer or oligomer preferably has a number average molecular weight of 500 to 1,000,000, and more preferably of 1000 to 20,000. Acrylic polymers and oligomers are well-known in the art, and can be prepared from monomers such as methyl acrylate, acrylic acid, methacrylic acid, methyl methacrylate, butyl methacrylate, cyclohexyl methacrylate, and the like. The active hydrogen functional group, e.g., hydroxyl, can be incorporated into the ester portion of the acrylic monomer. For example, hydroxy-functional acrylic monomers that can be used to form such resins include hydroxyethyl acrylate, hydroxybutyl acrylate, hydroxybutyl methacrylate, hydroxypropyl acrylate, and the like. Amino-functional acrylic monomers would include t-butylaminoethyl methacrylate and t-butylamino-ethylacrylate. Other acrylic monomers having active hydrogen functional groups in the ester portion of the monomer are also within the skill of the art.

In one embodiment of the invention, the acrylic resin is selected from the group of acrylic polymers and copolymers including Paraloid B-67, Paraloid K-120N, Paraloid KM-390, Paraloid KM-334, which are available from Dow Chemical. Generally, the coating composition will include less than about 10% by weight of the acrylic resin. In a preferred embodiment, the acrylic resin is Dow Paraloid B-67 and generally comprises about 1.7-8.5% by weight of the coating composition. In another embodiment, the acrylic resin is incorporated into the coating composition as an acrylic resin solution. The acrylic resin solution includes Dow Paraloid B-67 and a compatible solvent, such as parachlorobenzotrifluoride for example, and generally comprises about 2.2-11.0% by weight of the coating composition. It has been found that using the acrylic resin solution results in an increased, i.e. faster, processing time of the coating composition.

The coating composition further includes at least two biobased materials. The biobased materials, as used in conjunction with the invention, may also be known as renewable resources. As determined by the United States Secretary of Agriculture, biobased products are commercial or industrial products (other than food or feed) composed wholly or in significant part of biological products including renewable agricultural materials (plant, animal, and marine materials) or forestry materials, such as lumber, plywood, paper, and materials derived from these resources.

In one embodiment of the invention, the at least two biobased materials are selected from the group consisting of a vegetable oil, a natural fiber material, flour material, aramid pulp, and mixtures thereof.

Suitable vegetable oils that may be used in the coating solution of the invention include palm oil, soybean oil, rapeseed oil, canola oil, sunflower oil, peanut oil, cottonseed oil, coconut oil, olive oil and mixtures thereof. In one embodiment of the invention, the vegetable oil is soybean oil. In yet another embodiment of the invention, the vegetable oil is epoxidized soybean oil. The vegetable oil may be included in an amount from about 0.6-11.0% by weight of the coating composition.

Suitable natural fiber material that may be used in the coating solution of the invention include examples of such a fiber are natural fibers such as cellulose, silk, wool, and chitosan. In an embodiment of the invention, the natural fiber material is a natural cellulose fiber material known as Arbocel BE-600 and supplied by J. Rettenmaier & Sohne GMBH & Co. The natural fiber material may be included in an amount from about 5.5-22.0% by weight of the coating composition. The natural fiber material provides enhanced lateral strength and enhanced stain blocking properties to the cured coating.

In another embodiment of the invention, at least one tackifier, the block copolymer, the acrylic resin, at least two biobased materials are dissolved and/or dispersed in an organic solvent system to form the coating composition. A variety of solvents may be used either alone or in combination with one another. Suitable solvents which are commonly used include, for example, aromatic hydrocarbons, cycloaliphatic hydrocarbons, terpenes, unsaturated hydrocarbons, and halogenated aliphatic and aromatic hydrocarbons. Suitable solvents may include, but are not limited to, toluene, xylene, benzene, halogenated benzene derivatives, ethyl benzene, mineral spirits, odorless mineral spirits, naphtha, cyclohexane, parachlorobenzotrifluoride (PCTBF), propylene, ethylene carbonate, nitropropane, acetone, ethyl acetate, propyl acetate, butyl acetate, and isobutyl isobutyrate.

In one embodiment of the invention, the solvent system includes odorless mineral spirits and PCTBF and comprises about 33.0-88.2% by weight of the coating composition. Generally, the coating composition will include less than about 55.0% by weight of the solvent system. PCTBF is also known as OXSOL 100 and supplied by the Occidental Petroleum Corporation.

In another embodiment of the invention, the solvent system provides a calculated VOC content of less than 250 g/L for the coating composition. The amount of the at least one tackifier, the block copolymer, the acrylic resin, and at least two biobased materials contained within the coating composition allows for the overall reduction in the amount of solvent needed to solvate and/or disperse the components of the coating composition. This reduction of solvent directly lowers VOC emissions during application of the coating composition to a substrate. Further, PCTBF is exempt from federal and state VOC restrictions.

In addition to the use of a solvent system, the viscosity of a coating composition may often be reduced by warming the coating composition. Prior to warming, the viscosity of the coating composition is in the range from about 4,500-5,500 cps at 77° F. The coating composition should be heated to a temperature between about 90° F. and 110° F. with the use of heat bands or a heat exchanger to ensure proper viscosity for maximum performance during application of the coating composition. Heating of coating composition to the suggested temperature range is required during application in both cold weather and warm weather conditions in order to maximize uniform performance coverage.

Additionally, the desired viscosity of the coating composition often depends on the method of application of the coating composition. Depending on the area of the structure to be covered, a 4-inch or 6-inch or brush may be used to apply the coating composition of the invention. For flashings or tight areas, 3-inch or 6-inch rollers and 3-inch or 4-inch brushes are suitable for most applications. When spraying the coating composition of the invention, the utilization of pumps such as the Graco GH 733, Graco GH 833, Graco King 45:1, Bulldog 30:1, HydraMax or similar may be utilized and should be sprayed at a pressure between about 2,500-3,000 PSI.

Additionally, the coating composition may additional materials including, but not limited to, fillers, pigments, fire and smoke suppressants, corrosion inhibitors, rheology control agents, antioxidants, dispersing agents, UV stabilizers, masking agents, and flow control additives. Each of these other materials can be used in any amount that is used by one of ordinary skill in the art to prepare coating compositions. In one embodiment of the invention, the coating composition includes additives selected from the group consisting of a pigment, an anti-oxidant, a UV stabilizer, a fire and smoke suppressant, and a masking agent. In another embodiment, the masking agent is a vanilla-scented masking agent and comprises about 0.1-5.5% by weight of the coating composition. In yet another embodiment, the fire and smoke suppressant is alumina trihydrate and comprises about 2.8-11.0% by weight of the coating composition. In still yet another embodiment of the invention, the antioxidant is a hindered phenolic antioxidant and comprises about 0.1-5.5% by weight of the coating composition. The antioxidant is included in the coating composition in order to reduce the effect of chalking and cracking in the applied coating.

The pigment of the coating composition may be a reflective pigment. After the coating composition has been applied the surface of a structure and cured, the reflective pigment minimizes the effect of UV rays of light as well as reducing the effect of solar heat on the coating. An example of a reflective pigment includes titanium dioxide, as well as the mineral forms of titanium dioxide which includes rutile, anatase, and brookite. The reflective pigment is included in an amount of about 5.5-22.0% by weight of the coating composition.

Another aspect of the invention is to provide a roofing primer composition. The roofing primer composition includes at least one tackifier, a block copolymer, an acrylic resin, at least one flour material, and an organic solvent system. The roofing primer composition is a composition that is applied to various roof systems prior to the application of the non-aqueous coating composition previously described herein. The various roof systems include built-up roofs (BUR), modified bitumen roofing (Mod Bit), other similar roofing membranes that can cause staining of the cured non-aqueous coating. The solvent system of the roofing primer composition, which will be described in further detail, as well as the non-aqueous coating composition degrades the components of the various roof systems and liberates the petrochemicals in the asphalt portion of the roof systems which are then free to migrate through the surface of the cured coating composition. The migration of these chemicals causes discoloration of the cured coating composition and results in a reduction of UV reflectivity as well as visual unsightliness. It has been determined that roofing primer composition, upon curing, provides enhanced stain-blocking properties for the non-aqueous coating composition that is subsequently applied onto the cured roofing primer.

In yet another embodiment of the invention, the tackifier the tackifier is selected from the group consisting of an aliphatic hydrocarbon resin, a polybutene hydrocarbon resin, a polyterpene hydrocarbon resin, and mixtures thereof. In one embodiment, the tackifier of the roofing primer composition is a hydrocarbon resin. The hydrocarbon resins, as previously described for use in the non-aqueous coating composition, are also suitable for use in the roofing primer composition. In one embodiment of the invention, the tackifier is Eastotac™ H-130 and generally comprises about 4.6-18.3% by weight of the roofing primer composition.

Useful block copolymers of the roofing primer composition are well-known in the art and are commercially available. In one embodiment of the invention, the block copolymer is selected from the group consisting of styrene-isoprene-styrene block copolymers, styrene-butadiene-styrene block copolymers, and styrene-ethylene/butylene-styrene block copolymers and mixtures thereof. The block copolymer, as previously described for use in the non-aqueous coating composition, are also suitable for use in the roofing primer composition. In one embodiment of the invention, the block copolymer is Calprene H-6110 and/or Kraton G1652 and generally comprises about 6.9-22.8% by weight of the roofing primer composition.

The acrylic resin of the roofing primer composition is an acrylic polymer or oligomer. The acrylic resin, as previously described for use in the non-aqueous coating composition, are also suitable for use in the roofing primer composition. Generally, the roofing primer composition will include less than 30.0% by weight of the acrylic resin. In one embodiment of the invention, the acrylic resin is either Dow Paraloid B-67, NeoCryl B-725, which is available from DSM NeoResins, or mixtures thereof, and generally comprises about 7.0-28.2% by weight of the roofing primer composition. In a preferred embodiment, the acrylic resin comprises about 15.0-20.0% by weight of the roofing primer composition. In another embodiment, the acrylic resin is incorporated into the roofing primer composition as an acrylic resin solution. The acrylic resin solution includes Dow Paraloid B-67 and a compatible solvent, such as parachlorobenzotrifluoride for example, and generally comprises about 9.1-36.6% by weight of the roofing primer composition. In a preferred embodiment, the acrylic resin solution comprises about 25.0-30.0% by weight of the roofing primer composition. It has been found that using the acrylic resin solution results in an increased, i.e. faster, processing time of the roofing primer composition.

In still yet another embodiment of the invention, the roofing primer composition includes at least one flour material selected from the group consisting of ground cereal grains, ground seeds, and ground roots. The at least one flour material is selected from the group consisting of wheat flour, acorn flour, almond flour, rice flour, chestnut flour, corn flour, potato flour, rye flour, and tapioca flour. In one embodiment of the invention, the at least one flour material is corn flour and generally comprises about 6.8-18.3% by weight of the roofing primer composition. The at least one flour material provides enhanced lateral strength and enhanced stain blocking properties to the cured roof primer coating.

In another embodiment of the invention, the at least one tackifier, the block copolymer, the acrylic resin, and the at least one flour material are dissolved and/or dispersed in an organic solvent system to form the roofing primer composition. The solvent system, as previously described for use in the non-aqueous coating composition, is also suitable for use in the roofing primer composition. In one embodiment of the invention, the solvent system includes odorless mineral spirits and PCTBF may comprise in the range 25.7-63.6% by weight of the roofing primer composition. Generally, the roofing primer composition will include less than about 40.0% by weight of the solvent system.

In another embodiment of the invention, the solvent system provides a calculated VOC content of less than 250 g/L for the roofing primer composition. The amount of the at least one tackifier, the block copolymer, the acrylic resin, and the at least one flour material contained within the roofing primer composition allows for the overall reduction in the amount of solvent needed to solvate and/or disperse the components of the roofing primer composition. This reduction of solvent directly lowers VOC emissions during application of the roofing primer composition to a substrate. Further, PCTBF is exempt from federal and state VOC restrictions.

In addition to the use of a solvent system, the viscosity of a roofing primer composition may often be reduced by warming the roofing primer composition. Prior to warming, the viscosity of the roofing primer composition is in the range from about 7,000-8,000 cps at 77° F. The roofing primer composition should be heated to a temperature between about 90° F. and 110° F. with the use of heat bands or a heat exchanger to ensure proper viscosity for maximum performance during application of the roofing primer composition. Heating of roofing primer composition to the suggested temperature range is required during application in both cold weather and warm weather conditions in order to maximize uniform performance coverage.

As previously described for the non-aqueous coating composition, the desired viscosity of the roofing primer composition often depends on the method of application of the coating composition. Depending on the area of the structure to be covered, a 4-inch or 6-inch or brush may be used to apply the roofing primer composition of the invention. For flashings or tight areas, 3-inch or 6-inch rollers and 3-inch or 4-inch brushes are suitable for most applications. When spraying the roofing primer composition of the invention, the utilization of pumps such as the Graco GH 733, Graco GH 833, Graco King 45:1, Bulldog 30:1, HydraMax or similar may be utilized and should be sprayed at a pressure between about 2500-3000 PSI.

Additionally, the roofing primer composition may additional materials including, but not limited to, fillers, pigments, fire and smoke suppressants, corrosion inhibitors, antioxidants, rheology control agents, dispersing agents, UV stabilizers, masking agents, and flow control additives. Each of these other materials can be used in any amount that is used by one of ordinary skill in the art to prepare coating compositions. In one embodiment of the invention, the roofing primer composition includes additives selected from the group consisting of a pigment and a masking agent. In another embodiment, the masking agent is a vanilla-scented masking agent and comprises about 0.1-4.6% by weight of the roofing primer composition. In yet another embodiment, the pigment is a silver pigment and comprises about 3.7-9.1% by weight of the roofing primer composition. In still yet another embodiment, the fire and smoke suppressant is alumina trihydrate and comprises about 2.8-11.0% by weight of the coating composition. In another embodiment of the invention, the antioxidant is a hindered phenolic antioxidant and comprises about 0.1-5.5% by weight of the coating composition. The antioxidant is included in the coating composition in order to reduce the effect of chalking and cracking in the applied coating.

The following Examples illustrate the components, as well as amounts, of the coating composition. These Examples are to be construed as merely illustrative, and not limitative of the remainder of the disclosure in any way whatsoever.

### EXAMPLES

### Example 1

### Non-Aqueous Coating Composition

| Component | Range Wt. % | Preferred Wt. % |
|---|---|---|
| Odorless Mineral Spirits | 16.5-44.1 | 29.2 |
| OXSOL 100 | 16.5-44.1 | 24.8 |
| H-130 Resin | 5.5-22.0 | 6.6 |
| Acrylic Resin Solution | 2.2-11.0 | 3.8 |
| (Acrylic Resin alone) | (1.7-8.5) | (2.9) |
| 6110/1652 Block Copolymer | 8.3-27.6 | 11.8 |
| Smoke & Fire Suppressant | 2.8-11.0 | 4.4 |
| Masking Agent | 0.1-5.5 | 0.3 |
| Antioxidant | 0.1-5.5 | 0.3 |
| Titanium Dioxide | 5.5-22.0 | 9.0 |
| Epoxidized Soybean Oil | 0.6-11.0 | 0.8 |
| Arbocel BE-600 Cellulose | 5.5-22.0 | 9.0 |
| Aramid Pulp | 0.02-5.5 | 0.02 |

### Example 2

### Roofing Primer Composition

| | | Preferred |
|---|---|---|
| Component | Range Wt. % | Wt. % |
| Odorless Mineral Spirits | 13.7-36.6 | 21.1 |
| OXSOL 100 | 12.0-27.0 | 13.0 |
| H-130 Resin | 4.6-18.3 | 4.8 |
| Acrylic Resin Solution | 9.1-36.6 | 25.1 |
| (Acrylic Resin alone) | (7.0-28.2) | (19.3) |
| 6110/1652 Block Copolymer | 6.9-22.8 | 9.9 |
| Corn Flour | 6.8-18.3 | 16.7 |
| Smoke & Fire Suppressant | 2.8-11.0 | 4.2 |
| Antioxidant | 0.1-5.5 | 0.3 |
| Masking Agent | 0.1-4.6 | 0.3 |
| Silver Pigment | 3.7-9.1 | 4.6 |

The coating composition made in accordance the present invention is an elastomeric, liquid-applied roof membrane containing biobased materials that meets the criteria established by the USDA for the BioPreferred program. After the coating composition is applied to the surface of a structure, the solvent system evaporates leaving a water impervious, elastomeric coating on the structure. As the coating of the present invention forms, it exhibits little to no aeration. The improved release of trapped air to the surface of the coating provides a coating without pinholes or blisters which lead to weak spots in the coating. Finally, in some embodiments of the present invention, the coating exhibits improved UV resistance which results in yellowing and chalking of the coating over time and provides enhanced stain-blocking properties by preventing the migration of petrochemicals in the underlying asphalt through the surface of the coating.

The invention has been described with respect to several embodiments. This description is not intended as a limitation. Other modifications or variations in the specific form shown and described will be apparent to those skilled in the art and will fall within the scope of the invention and the scope of the following claims.

What is claimed is:

1. A non-aqueous coating composition for waterproofing a surface of a roof, the composition comprising:
at least one tackifier;
a block copolymer selected from the group consisting of styrene-isoprene-styrene block copolymers, styrene-butadiene-styrene block copolymers, and styrene-ethylene/butylene-styrene block copolymers and mixtures thereof;
an acrylic resin;
at least two biobased materials; and
an organic solvent system.

2. The composition of claim 1, wherein the composition includes by weight percent of the total composition:

| | |
|---|---|
| at least one tackifier | 5.5-22.0% |
| block copolymer | 8.3-27.6% |
| acrylic resin | 1.7-8.5% |
| at least two biobased materials | 6.1-33.0% |
| organic solvent system | 33.0-88.2% |

3. The composition of claim 1, wherein the tackifier is selected from the group consisting of an aliphatic hydrocarbon resin, a polybutene hydrocarbon resin, a polyterpene hydrocarbon resin, and mixtures thereof.

4. The composition of claim 3, wherein the block copolymer is a styrene-ethylene/butylene-styrene block copolymer.

5. The composition of claim 1, wherein the solvent system comprises a mixture of parachlorobenzotrifluoride and a hydrocarbon solvent.

6. The composition of claim 1, wherein the at least two biobased materials are selected from the group consisting of a vegetable oil, a natural fiber material, flour material, aramid pulp, and mixtures thereof.

7. The composition of claim 6, wherein the at least one vegetable oil is selected from the group consisting of palm oil, soybean oil, epoxidized soybean oil, rapeseed oil, canola oil, sunflower oil, peanut oil, cottonseed oil, coconut oil, olive oil and mixtures thereof.

8. The composition of claim 7, wherein the soybean oil is epoxidized soybean oil.

9. The composition of claim 1 further comprising at least one additive selected from the group consisting of a pigment, an anti-oxidant, a UV stabilizer, a fire and smoke suppressant, and a masking agent.

10. The composition of claim 1, wherein the composition has a VOC content of less than 250 g/L.

11. The composition of claim 1, wherein the composition has a viscosity of about 4,500-5,500 cps at 77° F.

12. A roofing primer composition comprising:
at least one tackifier;
a block copolymer selected from the group consisting of styrene-isoprene-styrene block copolymers, styrene-butadiene-styrene block copolymers, and styrene-ethylene/butylene-styrene block copolymers and mixtures thereof;
an acrylic resin;
at least one flour material selected from the group consisting of ground cereal grains, ground seeds, and ground roots; and
an organic solvent system.

13. The composition of claim 12, wherein the composition includes by weight percent of the total composition:

| | |
|---|---|
| at least one tackifier | 4.6-18.3% |
| block copolymer | 6.9-22.8% |
| acrylic resin | 7.0-28.2% |
| at least one flour material | 6.8-18.3% |
| organic solvent system | 25.7-63.6% |

14. The composition of claim 12, wherein the tackifier is selected from the group consisting of an aliphatic hydrocarbon resin, a polybutene hydrocarbon resin, a polyterpene hydrocarbon resin, and mixtures thereof.

15. The composition of claim 14, wherein the block copolymer is a styrene-ethylene/butylene-styrene block copolymer.

16. The composition of claim 12, wherein the solvent system comprises a mixture of parachlorobenzotrifluoride and a hydrocarbon solvent.

17. The composition of claim 12 further comprising at least one additive selected from the group consisting of a pigment, an antioxidant, a fire and smoke suppressant, and a masking agent.

18. The composition of claim 12, wherein the at least one flour material is selected from the group consisting of wheat flour, acorn flour, almond flour, rice flour, chestnut flour, corn flour, potato flour, rye flour, and tapioca flour.

19. The composition of claim 12, wherein the composition has a VOC content of less than 250 g/L.

20. The composition of claim 12, wherein the composition has a viscosity of about 7,000-8,000 cps at 77° F.
